(19) United States
(12) Patent Application Publication
(10) Pub. No.: US 2010/0132633 A1
(43) Pub. Date: Jun. 3, 2010

(54) BIOMASS GASIFICATION REACTOR

(75) Inventors: Ke Liu, Irvine, CA (US); Vladimir Zamansky, Oceanside, CA (US); Lingzhi Zhang, Mission Viejo, CA (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/493,271

(22) Filed: Jun. 29, 2009

(51) Int. Cl. F02B 43/08; B01J 8/00; B09B 3/00; C10J 3/46; C01B 3/38

(52) U.S. Cl. 123/3; 422/211; 252/373; 422/187; 429/19

(57) ABSTRACT

In one aspect, the present invention provides a biomass gasifier comprising a reactor. The reactor includes (i) an inlet for biomass, (ii) an inlet for an oxygen-containing gas, (iii) an inlet for steam, (iv) an outlet for reactor product gas, (v) an outlet for ash, (vi) a biogas exit conduit coupled to the outlet for the reactor product gas and (vii) an inlet for a secondary oxygen source. The biogas exit conduit includes a catalytic partial oxidation unit, the catalytic partial oxidation unit is substantially restricting the biogas exit conduit. A system and method for biomass gasification is also provided.

### BACKGROUND

The invention relates to a biomass gasification reactor. In addition, the present disclosure relates to a system and method of carrying out biomass gasification.

Biomass gasification is a flexible and efficient technology for utilizing a widely available domestic renewable resource. Gasification of biomass is another energy generation option. It uses renewable feedstock—biomass. Biomass encompasses a wide spectrum of materials. Some examples of biomass include wood, grass, corn stoves and other plant derived feedstocks. If biomass is utilized in gasification, the amount of CO₂ released in the environment due to gasification, corresponds to the amount of CO₂ consumed during growth of plants. Thus gasification or combustion of plant biomass does not add extra CO₂ to the environment. Therefore, use of biomass is considered carbon neutral. The plant biomass can be grown relatively quickly as compared to other carbonaceous feedstocks. Utilization of biomass feedstocks helps reduce dependence on fossil fuel since they are renewable and can be grown relatively quickly. Thus, the use of biomass for power generation is attractive from the perspective of sustainability and environmental impact. Syngas production from biomass has become increasingly important in terms of sustained and economic co-generation (co-gen) of power and heat or biofuels from renewable resources, especially for the rural economy and agricultural industry as a whole.

Biomass contains a large amount of oxygen and moisture as compared to coal. The ash content can also be significantly higher; the exact quantity of ash depends on the source of biomass employed. The syngas produced contains high concentrations of tar and the gasification technology relies on a series of complicated units for syngas cleaning/conditioning to remove the tar. Tars easily condense at reduced temperatures and block or foul particulate filters, other equipment and subsequent gas engines or turbines. High operating temperatures of the gasifier such as an oxygen blow gasifier require expensive air separation unit, in addition to having to use a large quantity of biomass feed. At lower operating temperature of the gasifier the conversion of tar to syngas is reduced and an elaborate clean up process may be required to remove the tar from the syngas produced. Tars are also present in wastewater and physical methods of wet or dry scrubbing for their removal are cost prohibitive and present an environmental liability. However, operational issues and process complexity resulting from the removal of tars and other impurities from the biomass syngas stream have been major barriers for commercialization of biomass gasification based power generation systems. Unsuccessful removal of tars and overloading of tar filters have been responsible for unreliable system operations and frequent system shut-downs.

Therefore, further improvements are required for tar removal in the biomass gasification process. In particular further improvements are needed to provide efficient conversion of tar and produce syngas with less amount of tar, ash and impurities. In addition, further improvements are required to obtain pressurized gasifier operations with biomass, increasing operational flexibility in terms of system efficiency and/or throughput, as well as reducing the cost of the overall system. The present invention provides additional solutions to these and other challenges associated with biomass gasification.

### BRIEF DESCRIPTION

In one aspect, the present invention provides a biomass gasifier comprising a reactor. The reactor includes (i) an inlet for biomass, (ii) an inlet for an oxygen-containing gas, (iii) an inlet for steam, (iv) an outlet for reactor product gas, (v) an outlet for ash, (vi) a biogas exit conduit coupled to the outlet for the reactor product gas and (vii) an inlet for a secondary oxygen source. The biogas exit conduit includes a catalytic partial oxidation unit, the catalytic partial oxidation unit is substantially restricting the biogas exit conduit.

In another aspect, the present invention provides a biomass gasifier comprising (a) a reactor. The reactor includes (i) an inlet for biomass, (ii) an inlet for an oxygen-containing gas, (iii) an inlet for steam, (iv) an outlet for reactor product gas, (v) an outlet for ash, (vi) a cyclone coupled to the outlet for the reactor product gas and (vii) an inlet for a secondary oxygen source. The cyclone includes a catalytic partial oxidation unit and the catalytic partial oxidation unit is substantially restricting the biogas exit conduit.

In yet another aspect, the present invention provides a system comprising: a biomass feed unit; a biomass gasifier; a gas cleanup unit; and a power production unit. The biomass gasifier comprises a reactor. The reactor includes (i) an inlet for biomass, (ii) an inlet for an oxygen-containing gas, (iii) an inlet for steam, (iv) an outlet for reactor product gas, (v) an outlet for ash, (vi) a biogas exit conduit, and (vii) an inlet for a secondary oxygen source. The biogas exit conduit is coupled to the outlet for the reactor product gas. The biogas exit conduit includes a catalytic partial oxidation unit, and the catalytic partial oxidation unit substantially restricting the biogas.

In yet another aspect, the present invention provides a method for biomass gasification. The method comprising (a) heating biomass in the presence of steam and oxygen to produce a biogas; (b) flowing a substantial amount of the biogas through the catalytic partial oxidation unit to produce a reactor product gas; and (c) collecting the reactor product gas. The heating of the biogas is carried out in a reactor comprising (i) an inlet for biomass, (ii) an inlet for an oxygen-containing gas, (iii) an inlet for steam, (iv) an outlet for reactor product gas, (v) an outlet for ash, (vi) a biogas exit conduit and (vii) an inlet for a secondary oxygen source. The biogas exit conduit is coupled to the outlet for the reactor product gas, and the biogas exit conduit includes a catalytic partial oxidation unit. The catalytic partial oxidation unit substantially restricting the biogas exit conduit.

These and other features, aspects, and advantages of the present invention may be understood more readily by reference to the following detailed description.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 is a schematic representation of a biomass gasifier reactor, in accordance with one aspect of the invention.

FIG. 2 is a schematic representation of a biomass gasifier reactor, in accordance with one aspect of the invention.

FIG. 3 is a schematic representation of a biomass gasifier reactor with clean-up system, in accordance with one aspect of the invention.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

The term “zone” used herein refers to a region of the reactor. The zones are not physically separated with a separation baffle unless specifically noted. Thus, a zone corresponds to a processing region within the reactor. It is also conceivable that a zone may further include sub-zones or regions that include, for example, typical unit processes and operations involved in gasification such as drying, devolatilization and carbon conversion reactions. These sub-zones may be overlapping with each other. The zones on the other hand may be fairly distinct. In one embodiment, there is a partial overlap of the successive zones.

As noted, in one embodiment the present invention provides a biomass gasifier comprising a reactor. The reactor includes (i) an inlet for biomass, (ii) an inlet for an oxygen-containing gas, (iii) an inlet for steam, (iv) an outlet for reactor product gas, (v) an outlet for ash, (vi) a biogas exit conduit coupled to the outlet for the reactor product gas and (vii) an inlet for a secondary oxygen source. The biogas exit conduit includes a catalytic partial oxidation unit, the catalytic partial oxidation unit is substantially restricting the biogas exit conduit.

The term biomass covers a broad range of materials that offer themselves as fuels or raw materials and are characterized by the fact that they are derived from recently living organisms (plants and animals). This definition clearly excludes traditional fossil fuels, since although they are also derived from plant (coal) or animal (oil and gas) life, it has taken millions of years to convert them to their current form. Thus the term biomass includes feedstocks derived from materials such as wood and tree based materials, forest residues, agricultural residues and energy crops. The wood and tree materials and forest residues may include materials such as wood, woodchips, sawdust, bark, seeds, straw, grass, and the like, from naturally occurring plants. It includes agricultural and forestry wastes. Agricultural residue and energy crops may further include short rotation herbaceous species, husks such as rice husk, coffee husk etc., maize, corn stover, oilseeds, residues of oilseed extraction, cellulosic fibers like coconut, jute, and the like. The oilseeds may be typical oil bearing seeds like soybean, camolina, canola, rapeseed, corn, cottonseed, sunflower, safflower, olive, peanut, and the like. Agricultural residue also includes material obtained from agro-processing industries such as deoiled residue, for example, a deoiled soybean cake, deoiled cottonseed, deoiled peanut cake, and the like, gums from oil processing industry such as gum separated from the vegetable oil preparation process—e.g. lecithin in the case of soybean, bagasse from sugar processing industry, cotton gin trash and the like. It also includes other wastes from such industries such as coconut shell, almond shell, walnut shell, sunflower shell, and the like. In addition to these wastes from agro industries, biomass may also include wastes from animals and humans. In some embodiments, the biomass includes municipal waste or yard waste, sewage sludge and the like. In some other embodiments, the term biomass includes animal farming byproducts such as piggery waste or chicken litter. The term biomass may also include algae, microalgae, and the like.

Thus, biomass covers a wide range of materials, characterized by the fact that they are derived from recently living plants and animals. All of these types of biomass contain carbon, hydrogen and oxygen, similar to many hydrocarbon fuels; thus the biomass can be used to generate energy. Biomass includes components such as oxygen, moisture and ash and the proportion of these depends on the type and source of the biomass used. Due to the presence of these components, the gasification characteristics of biomass are much different than that of coal. Due to the presence of these components that do not add to the heating value, the calorific value of biomass is much lower than that of coal. The calorific value and composition of biomass also depend on other factors such as seasonal and geographical variability.

Gasification involves a thermal processing of the biomass with an oxygen-containing gas and steam to produce a reactor product gas. In one embodiment, the reactor product gas is a synthesis gas. Synthesis gas or syngas is a mixture of gases, containing carbon monoxide (CO) and hydrogen (H₂). The oxygen-containing gas is an oxygen source also referred to as an oxygen-supplying compound—this may be oxygen itself, air, steam, carbon dioxide, or some combination of these.

Gasification involves a number of reactions such as oxidation reactions,

C+½O₂═CO (Reaction 1)

CO+½O₂═CO₂ (Reaction 2)

H₂+½O₂═H₂O (Reaction 3)

the Boudouard reaction,

C+CO₂ [symbol] 2CO (Reaction 4)

the steam gasification reaction,

C+H₂O [symbol] CO+H₂ (Reaction 5)

the water-gas shift reaction,

CO+H₂O [symbol] CO₂+H₂ (Reaction 6)

and the methanation reaction

C+2H₂ [symbol] CH₄ (Reaction 7)

A typical biomass can be represented by a chemical formula such as CₓH_{y}O_{z}, where x˜1, y˜2, and z˜1. The gasification process of such biomass can be generically represented as

CH₂O [symbol] CO+H₂ (Reaction 8)

The oxygen content of the biomass can be advantageously used to minimize the amount of the externally added oxidant. However, in order for biomass gasification to proceed accordingly to Reaction 8, additional heat must be supplied.

Thermal processing involves processing of the biomass by processes such as pyrolysis, partial oxidation, complete oxidation, or a combination of these processes. The term “Pyrolysis” refers to the heating of biomass in the absence of any oxygen. “Partial oxidation” refers to the heating of the biomass in the presence of sub-stoichiometric oxygen. “Complete oxidation” refers to the heating of the biomass in the presence of stoichiometric or excess amounts of oxygen. Depending upon the configuration of the reactor in which the thermal processing is carried out, more than one of these reactions may be taking place in a single reactor. Hence, although the term gasification used herein refers predominantly to oxygen-starved reactions such as pyrolysis and partial oxidation, the conditions for complete oxidation may also be present in the gasification reactor. Gasification also involves reaction of the biomass with steam.

The term “gasifier” as used refers to a reaction vessel in which the gasification is carried out. The gasifiers, based on gas velocities and configuration, can be fixed bed, fluidized bed or entrained flow gasifiers or some variation of these. The types and extent of reactions in a gasifier depends upon design and operating conditions in the gasifier. Entrained flow gasifiers are generally employed for large-scale gasification operations. Typically, these gasifiers use pure oxygen as a gasifying medium instead of air. Additionally, use of pure oxygen results in high temperatures, enabling almost complete tar conversion, and the ash to be melted as slag. However, the oxygen blow gasifier require expensive air separation unit, in addition to having to use a large quantity of biomass. In one embodiment, the gasifier is an oxygen blow gasifier. In another embodiment, the gasifier is an air blown gasifier.

In one embodiment, the gasifier is operated at relatively high temperatures so that at least a substantial portion of the tar component is eliminated by cracking. In some embodiments, it is preferred to operate the gasifiers at temperatures higher than about 1000° C. In one embodiment, the temperatures in the gasifier are maintained in the range from about 1000° C. to about 1400° C. In another embodiment, the gasifier temperature is advantageously maintained between about 1300° C. and about 1400° C. In yet another embodiment, the gasifier may be maintained at even higher temperatures. For example, operation of the oxygen blown gasifier at temperatures of at least about 1500° C. resulting in tar levels of only about 1 ppm in the product gas. However, operation at such high temperatures requires a lot of energy and use of expensive refractory materials in the gasifier section, which may not be economically favorable. In one embodiment, the gasifier is operated at temperature a range from about 300° C. to about 850° C. In another embodiment, the gasifier is operated at temperature a range from about 650° C. to about 850° C. In one embodiment, the gasifier may be operated under pressure. In one embodiment, the gasifier may be operated at a pressure at a range from about 30 bars to about 85 bars. In another embodiment, the gasifier is operated at atmospheric pressure. In one embodiment, the tar conversion to syngas is carried out in-situ in the gasifier.

In one embodiment, the biomass and the oxygen-containing gas come in contact in the gasifier in the pre-gasification zone. The gasification of the biomass can produce biogas, tar, ash and other impurities. The biogas as used herein includes among others unreacted biomass particles, ash, tar, oxygen-containing gas, steam, carbon monoxide, hydrogen. In one embodiment, the biogas passed through an exit conduit which is coupled to the outlet for the reactor product gas. In one embodiment, the reactor includes baffles that allow a large amount of biogas to enter the exit conduit. The exit conduit includes a catalytic partial oxidation unit. The catalytic partial oxidation unit includes a catalytic partial oxidation catalyst. In one embodiment, the catalytic partial oxidation catalyst is at least one selected from the group consisting of supported Ni, Co, Fe, Ru, Rh, Pd, Pt or Ir catalysts. In one embodiment, the catalytic partial oxidation unit is maintained at a temperature in a range from about 600° C. to about 1150° C. In one embodiment, the biogas exit conduit is a cyclone. In another embodiment, the biogas exit conduit is coextensive with the catalytic partial oxidation unit. By a proper choice of reactor geometry and particle size of the feedstocks, flowrates and pressures of gases, gasification agents etc., the flow field inside the gasifier can be organized in such a way that all the biogas generated in the reactor is made to pass through the catalytic partial oxidation unit. In one embodiment, a secondary air stream can be introduced in the biogas exit conduit.

In one embodiment, the catalytic partial oxidation unit converts the tar to produce a clean reactor product gas. In one embodiment, the catalytic partial oxidation unit is a filter for the ash present in the biogas and does not allow the ash to penetrate through the catalytic partial oxidation catalyst. In another embodiment, the high temperature of the catalytic partial oxidation unit can melt the ash. In one embodiment, the melted ash can be dripped back to the gasification zone where the ash agglomeration occurs. In one embodiment, the gasifier includes an ash agglomeration and an ash rejection zone. The agglomerated ash can be collected at an outlet for the ash. In one embodiment, the outlet for ash is at the bottom of the gasifier. For example, the agglomerated ash can be separated and collected at the bottom of the gasifier via a lock-hopper. In one embodiment, when the unreacted biogas comes in contact with the catalytic partial oxidation catalyst is further reacted to produce reactor product gas. In one embodiment, the reactor product gas includes H₂, CO, CO₂, H₂O, N₂, CH₄, hydrocarbons containing from about C2 to about C6 carbon atoms. In another embodiment, the reactor product gas includes primarily H₂ and CO. In yet another embodiment, the reactor product gas comprises from about 5 to about 45 percent by volume hydrogen.

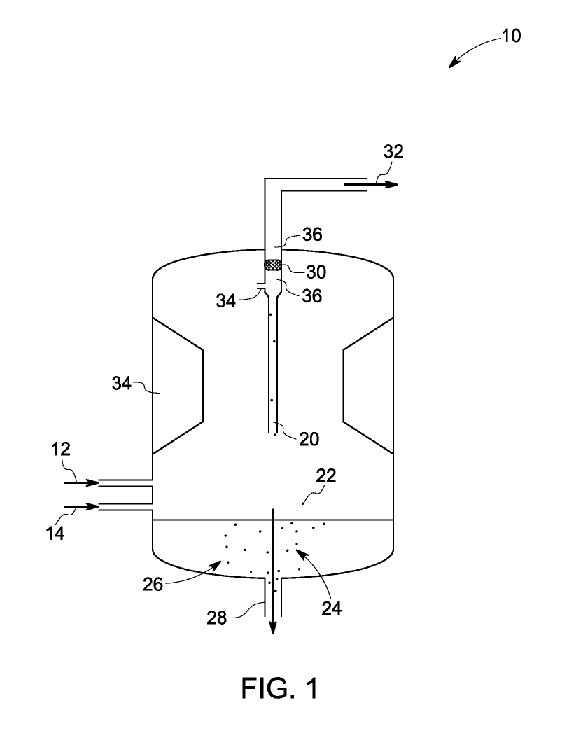

FIG. 1 is a biomass gasifier reactor (10) according to one embodiment of the present invention. The reactor includes an inlet for biomass (12) and inlet for oxygen containing gas and steam (14). The baffles (18) force the biomass and the mixture of oxygen containing gas and steam to the gasification zone via the pre-gasification zone (22). The biogas generated is led to the biogas exit conduit, which is a cyclone (20) where the biogas is contacted with the catalytic partial oxidation unit (30) and a stream of secondary air (34). The ash (24) does not pass through the catalytic partial oxidation unit and falls at the bottom zone of the reactor, which is the ash agglomeration zone (26). The agglomerated ash is collected via an outlet for ash (28). The reactor product gas (36) is then let out of the biomass gasifier reactor via an outlet (32).

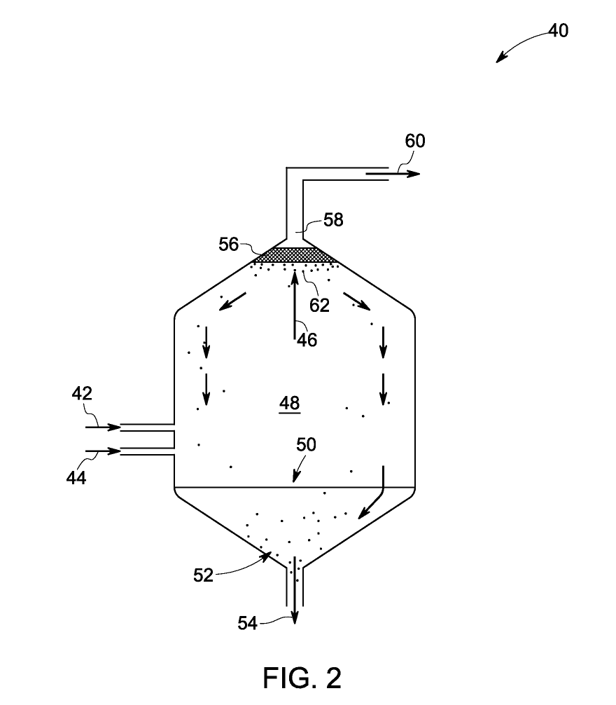

FIG. 2 is a biomass gasifier reactor (40) according to one embodiment of the present invention. The reactor includes an inlet for biomass (42) and inlet for oxygen containing gas and steam (44). The biomass and the mixture of oxygen containing gas and steam are let to the gasification zone via the pre-gasification zone (48). All the biogas generated (46) is led to the biogas exit conduit which is coextensive with the catalytic partial oxidation unit (56). The ash (62) does not pass through the catalytic partial oxidation unit and falls at the bottom zone of the reactor which is the ash agglomeration zone (50). The agglomerated ash (52) is collected via an outlet for ash (54). The tar present in the biogas on coming in contact with the catalytic partial oxidation unit is converted into the reactor product gas. The reactor product gas (58) is then let out of the biomass gasifier reactor via an outlet (60).

In one embodiment, the biomass may need a feed preparation step in a feed preparation unit, where it undergoes pre-processing prior to introducing the biomass in the gasifier. The feed preparation of the biomass can involve a single step or multiple steps. The feed preparation can optionally include sizing of the biomass to a particle size range appropriate for thermal processing. The sizing operation may include cutting, grinding, attrition, shearing etc. The lower particle size results in better reaction rates in thermal processing operations. However, more energy is required for the size reduction itself. Thus, there is a balance involved in the particle size used for thermal processing, and the power required for size reduction. In the case of biomass such as sawdust, the particles are of a lower size than the preferred size range. In such cases, the biomass may be subjected to agglomeration, densification or briquetting, to meet the required size and density criteria, by increasing the average size of the feedstock particles.

Apart from sizing the feed preparation of biomass may involve other pre-processing steps, such as, but not limited to, moisture removal, volatile reduction, and carbonization. Drying or moisture removal can be a separate preprocessing step in locations where waste heat is available. The step is especially preferred in the case of high-moisture content biomass, such as algae. In the case of other biomass with less than about 20% moisture, sufficient moisture removal can often occur in the pre-heating zone of the reactor in gasification step.

The feed preparation step may involve carbonization, wherein the biomass is heated to a temperature in a range from about 200° C. to about 400° C. This removes substantially all of the moisture and low volatile compounds from the biomass. The volatiles removed from the biomass may be condensed to a liquid—sometimes referred to as “pyrolysis oil”. This material has a good energy value that may be subsequently recovered. Usually, the volatile compounds in the biomass are responsible for the tar formation. Hence, the removal or reduction in quantity of the volatiles results in the desirable reduction of tar during gasification step.

In one embodiment, the resultant stream of reactor product gas, can be fed to a power production unit. In one embodiment, the stream of reactor product gas can be used for combustion in an internal combustion engine or a gas turbine, for generating mechanical or electrical power. The resultant stream may also be fed to fuel cells for the generation of power. The resultant stream of reactor product gas can also be used as a hydrogen source in chemical synthesis reactions. As non-limiting examples, the resultant stream of reactor product gas can be used as a hydrogen source in the hydrogenation reaction of oils; in hydrotreating processes; for hydrodesulfurization; or for other reactions which consume hydrogen.

The reactor product gas can be directly used in applications like power generation, mechanical work, or chemical synthesis. Typically the chemical synthesis reactions, such as the Fischer Tropsch synthesis reaction, are used to form synthetic hydrocarbons from synthesis gas. These reactions require the conditioning of reactor product gas, so as to maintain a desired proportion of carbon monoxide and hydrogen. The appropriate ratio of these compounds can be achieved by selective removal of either of the compounds. For example, if the amount of carbon monoxide in the reactor product is higher than the desired range, it can be selectively removed by membranes, or by preferential oxidation of CO.

In one embodiment, the reactor product gas can be used for heating applications. As an example, the reactor product gas can be used to fire a heater to produce thermal energy. In another embodiment, the reactor product gas can be used in a boiler to produce steam. The steam can be further used for heating purposes, process applications, or in a steam turbine or a gas turbine, to produce power. In another embodiment, the reactor product gas may be introduced in a F-T reactor for liquid biofuel production.

In one embodiment, the reactor product gas can be used in applications, at a desired location adjacent to the site of preparation. In another embodiment, the reactor product gas can be transported to other sites (sometimes distant), for storage, further processing, or use in a selected application. Those skilled in the art are familiar with storage and transportation techniques for such materials.

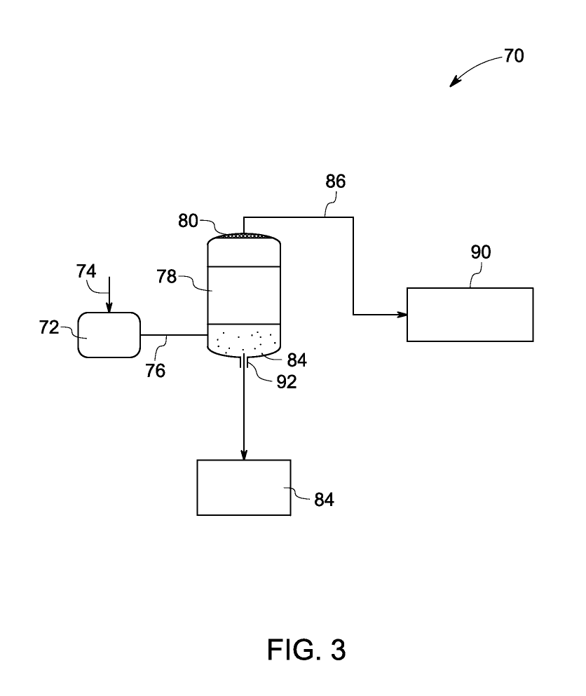

FIG. 3 shows a schematic representation of a distributed biomass to biofuel and/or biomass to power and heat co-generation system (70) according to one embodiment of the invention. The biomass (74) is fed into a dry feeding system (72) such as for example a Posimetric® solid pump or a lock-hopper system. The biomass feed particles (76) from the feeding system is introduced into a biomass gasifier (78) that may be maintained either at atmospheric or high pressure. The gasifier (78) includes a catalytic partial oxidation unit (80) that contains the catalytic partial oxidation catalyst. The reactor product gas and the unreacted biogas are contacted to the catalytic partial oxidation unit. In one embodiment, catalytic gasification of biogas and biomass particle occurs at the catalytic partial oxidation unit. Further tar that comes in contact with the catalytic partial oxidation unit is converted to the reactor product gas. The ash and other particulate matter that may be present in the biogas are not allowed to pass through the catalytic partial oxidation unit. The temperature of the catalytic partial oxidation unit aids to melt the ash. The melted ash is then taken back to the gasification zone where the ash gets agglomerated (84) and is collected at the bottom of the gasifier at an ash collection outlet (92). The reactor product gas (86) is substantially free of tar, ash and particulate matter is fed into a gas engine (90) for power generation.

The foregoing examples are merely illustrative, serving to exemplify only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A biomass gasifier comprising:
(a) a reactor comprising (i) an inlet for biomass, (ii) an inlet for an oxygen-containing gas, (iii) an inlet for steam, (iv) an outlet for reactor product gas, (v) an outlet for ash, (vi) a biogas exit conduit coupled to the outlet for the reactor product gas, the biogas exit conduit comprising a catalytic partial oxidation unit, the catalytic partial oxidation unit substantially restricting the biogas exit conduit, and (vii) an inlet for a secondary oxygen source.

2. The biomass gasifier of claim 1, wherein the biogas exit conduit is a cyclone.

3. The biomass gasifier of claim 1, wherein the biogas exit conduit is coextensive with the catalytic partial oxidation unit.

4. The biomass gasifier of claim 1, wherein the reactor comprises a pre-gasification zone.

5. The biomass gasifier of claim 1, wherein the reactor comprises an ash agglomeration zone.

6. The biomass gasifier of claim 1, wherein the reactor comprises baffles.

7. (canceled)

8. (canceled)

9. (canceled)

10. (canceled)

11. A system comprising:
a biomass feed unit;
a biomass gasifier comprising (a) a reactor comprising (i) an inlet for biomass, (ii) an inlet for an oxygen-containing gas, (iii) an inlet for steam, (iv) an outlet for reactor product gas, (v) an outlet for ash, (vi) a biogas exit conduit coupled to the outlet for the reactor product gas, the biogas exit conduit comprising a catalytic partial oxidation unit, the catalytic partial oxidation unit substantially restricting the biogas exit conduit, and (vii) an inlet for a secondary oxygen source;
a gas clean up unit; and
a power production unit.

12. The system of claim 11, wherein the biomass feed unit further comprises a feed preparation unit.

13. The system of claim 11, wherein the biogas exit conduit comprises a cyclone.

14. The system of claim 11, wherein the power production unit comprises a turbine.

15. The system of claim 11, wherein the power production unit comprises an internal combustion engine.

16. The system of claim 11, wherein the power production unit comprises a fuel cell.

17. A method for biomass gasification comprising:
(a) heating biomass in the presence of steam and oxygen to produce a biogas, said heating being carried out in a reactor comprising (i) an inlet for biomass, (ii) an inlet for an oxygen-containing gas, (iii) an inlet for steam, (iv) an outlet for reactor product gas, (v) an outlet for ash, (vi) a biogas exit conduit coupled to the outlet for the reactor product gas, the biogas exit conduit comprising a catalytic partial oxidation unit, the catalytic partial oxidation unit substantially restricting the biogas exit conduit, and (vii) an inlet for a secondary oxygen source;
(b) flowing a substantial amount of the biogas through the catalytic partial oxidation unit to produce a reactor product gas; and
(c) collecting the reactor product gas.

18. The method according to claim 17, wherein said heating is carried out at a temperature in a range of from about 300° C. to about 850° C.

19. The method according to claim 17, wherein said catalytic partial oxidation unit is operated at a temperature in a range from about 600° C. to about 1150° C.

20. The method according to claim 17, wherein said reactor product gas comprises from about 5 to about 45 percent by volume hydrogen.

21. The method according to claim 17, wherein said biomass is non-edible agricultural waste.
